(19) United States
(12) Patent Application Publication
(10) Pub. No.: US 2020/0285785 A1
(43) Pub. Date: Sep. 10, 2020

(54) STONEWORK DESIGN AND SELECTION APPARATUS AND METHOD

(71) Applicant: Steven R. Homola, Watertown, MN (US)

(72) Inventor: Steven R. Homola, Watertown, MN (US)

(21) Appl. No.: 16/805,311

(22) Filed: Feb. 28, 2020

Related U.S. Application Data
(60) Provisional application No. 62/815,774, filed on Mar. 8, 2019.

(51) Int. Cl. G06F 30/13; G06F 30/12; G06F 30/20

(52) U.S. Cl. CPC G06F 30/13; G06F 2111/16; G06F 30/20; G06F 30/12

(57) ABSTRACT

A computer-aided interactive design tool/apparatus that is capable of simplifying and organizing the process of selecting and procuring the correct stone and mortar for a given masonry project, such design apparatus including a large user-friendly interactive display monitor which is capable of visually displaying computer-generated stone/mortar combination panel images based on available stone and mortar selections of represented vendors made from easy-to-use interactive stone and mortar selection modules associated with the display.

### CROSS REFERENCE TO RELATED APPLICATIONS

This application is a nonprovisional application which claims the benefit of U.S. Provisional Patent Application Ser. No. 62/815,774, filed on Mar. 8, 2019, the contents of which is hereby incorporated by reference herein in its entirety.

### FIELD OF INVENTION

The present invention relates generally to the fields of masonry and construction, and more particularly to a computer-aided interactive design tool/apparatus that is capable of simplifying and organizing the process of selecting and procuring the correct stone and mortar for a given masonry project.

### BACKGROUND

The statements in this section merely provide background information related to the present disclosure and may not constitute prior art.

For any given masonry project, whether it be for the exterior or interior of a home, office building, landscaping project, etc., the customer and contractor want to achieve the correct stone/mortar balance and design selection which fits the style and surroundings of the environment. This selection process can depend on many factors, including without limitation, stone placement location, the colors of the surrounding environment/house, the landscape, and whether the overall look and feel is to be formal or informal. This selection process can be extremely time consuming and challenging to everyone involved, as anxiety by this point is often running at a high level.

With such design considerations in mind, the conventional selection process generally involves the contractor and customer traveling to and visiting multiple vendor showrooms to view possible stone and mortar combinations. Such showrooms generally have sample panels which display various available stones at that site. However, these panels are static selection tools which are difficult to maneuver and/or change in any way. Moreover, these display panels may or may not include mortar, and likely do not provide any features for considering mortar joint variants, such as color, joint depth, joint width, patterns, joint finishes, surface finishes, etc. All of this is left to the imagination of the customer, who must physically try to mix and match samples to hopefully find a desired combination. Finally, this process almost always requires at least one, and oftentimes multiple, job site sample panels to be built so the customer can actually visualize how the final selection(s) will look before proceeding. This process, in general, is extremely time consuming and cumbersome, yet has been the standard practice in the masonry and construction industries for many years.

Therefore, it is evident that there is a distinct need in the field of masonry and construction for an improved apparatus and method for aiding in the stone and mortar design and selection process. With this objective in mind, an improved design apparatus and method is contemplated, where contractors and customers alike, at a single location, can utilize and apply their specific design considerations, and easily pick and choose, and mix and match, all the available stone/mortar combinations/variants of various local vendors. With this improved design apparatus, customers can generate and save at a single location multiple potential combinations for viewing and comparing during the final stonework selection process.

### SUMMARY

In furtherance of the foregoing objectives, the present invention is comprised generally of a computer-aided interactive design tool/apparatus that is capable of simplifying and organizing the process of selecting and procuring the correct stone (natural or artificial) and mortar for a given masonry project. In one embodiment, it is contemplated that a user-friendly interactive computer or television display monitor be provided which is capable of visually displaying computer-generated stone/mortar combination panel images based on available stone and mortar selections of a represented vendor(s). Upon selection of all vendors (or a particular desired vendor(s)), the associated vendor database(s) of stone and mortar samples may be accessed by the user for review and selection.

An additional feature may include a stone sample selection module, including a scrollbar, located adjacent a large central stone/mortar integration display on the interactive monitor. From this, a user may easily and quickly preview the various available options for stone, and make selections to be integrated into the main central image display. A similar mortar selection module with a scrollbar may also be provided for review and selection of desired mortar samples. With the selection of various available stone and mortar samples, the large central integrated image is easily and conveniently updated on a continuous basis so as to display the various selected combinations of stone and mortar. With a large life-like integrated display format, each user can mix and match stone and mortar combinations from selected vendors, as desired, and visually consider and save any number of desirable combinations for subsequent comparison and final selection.

In a similar manner, it is further contemplated that available options for sill stone selection may also be displayed and incorporated into the central integrated display image, such that the user can review a fully integrated display of selected exterior and sill stones, together with available mortar combinations. In this regard, visual displays of numerous available sill stone options can be incorporated into a similar sill stone selection module to modify the interactive display monitor. The sill stone display may be located immediately atop the combined stone/mortar display image, or elsewhere on the display, such that one can easily visualize the entire combination of selected stones and mortar together. In a similar manner, the sill selection module may be controlled with a user-interactive scroll bar capable of scrolling through numerous different combinations of stone selections.

Still further, it is contemplated that another selection module feature may also be incorporated into the interactive display monitor for controlling the selection of optional variants of the joints formed of mortar. Using the interactive technique of a scrollbar, in this embodiment, alterations can be performed on the mortar joints to change the joint depth, joint width, joint finishes, patterns, etc. Such alterations, as selected, are automatically integrated into the main central image display such that the user can visualize exactly how the stone and mortar joints come together as a finished unit.

In order to present the user with a more complete visual experience of the selected stone combination(s), it is also contemplated that a “project inspiration” module be provided which incorporates the composite display of user-selected images from the various selection modules into an integrated visual simulation comprising one or more completed sections of a home or other building. With this module, users may better visualize the selected stone combination in a more natural setting, such as in the front entryway to a home, or a stone veneer surface, flagstone, stone contouring, window accents, patios, atriums and other exterior enhancements, or interior accents to homes, such as for fireplaces, etc. In this manner, the user can better visualize the integration of some or all of the selected stone/mortar/sill/joint variations, etc., together in a more complete home environment.

The foregoing computer-aided interactive design tool/apparatus may also include an optional search feature which may be used to search and identify specific vendors, or known stone and mortar samples/colors, etc. Other features of the present invention may include the calculation and auto display of the estimated total cost for a given masonry project based on stored information of known labor intensity and stone material costs associated with selections made. The associated labor, material cost and estimated total project cost may be calculated and auto-populated on the monitor screen as selections are made and/or modified, thus keeping the contractor and customer fully aware of the potential cost for any given selection of materials.

Still further, all relevant data pertaining to selections made can also be auto-displayed and modified during the selection process in a title block on the monitor screen. This title block display could include, amongst other things, the name of the selected vendor(s), the stone and mortar selection, colors, pattern, geographic origin of stone, quarry location, sill style/color, joint width/depth/style, etc.

Further potential features could also be incorporated to enhance the interactive experience of selecting all design components for a particular masonry or construction project. This could include, amongst other things, similar selection modules for flagstone; siding/fascia/soffit/trim; roofing; cut stone for lintels, brackets, trim, etc.; and fireplaces. With the computer-aided interactive design tool/apparatus of the present invention, customers and contractors alike may visit a single virtual display showroom where all desired design criteria of a masonry project can be selected, modified and visualized without the stress and anxiety associated with the conventional process of travelling to multiple stone/mortar showroom locations.

The foregoing and additional features and advantages of the present invention will be more readily apparent from the following detailed description. It should be understood, however, that the description and specific examples herein are intended for purposes of illustration only and are not intended to limit the scope of the present disclosure or appended claims.

### DRAWINGS

The drawings described herein are for illustration purposes only and are not intended to limit the scope of the present disclosure in any way.

FIG. 1 is a front elevational view of a computer-aided interactive design tool/apparatus constructed in accordance with the present invention, showing an example of the interactive display panel with associated preview selection modules for stone, mortar, sill stone and joint variant options;

FIG. 2 is a diagrammatic flowchart showing the general process of the computer-aided interactive design tool/apparatus of FIG. 1, constructed in accordance with the present invention;

FIG. 3 is a front elevational view of an alternative embodiment of a computer-aided interactive design tool/apparatus constructed in accordance with the present invention, showing an alternative user-interactive display panel with associated preview selection modules for stone, mortar and sill stone options, and a separate project inspiration module for viewing selected stone combinations in a more natural home setting; and

FIG. 4 is a front elevation of a sample user-interactive display panel showing the manner in which selected stones, mortars and other combined variations may be displayed as a composite part of different selectable natural home settings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

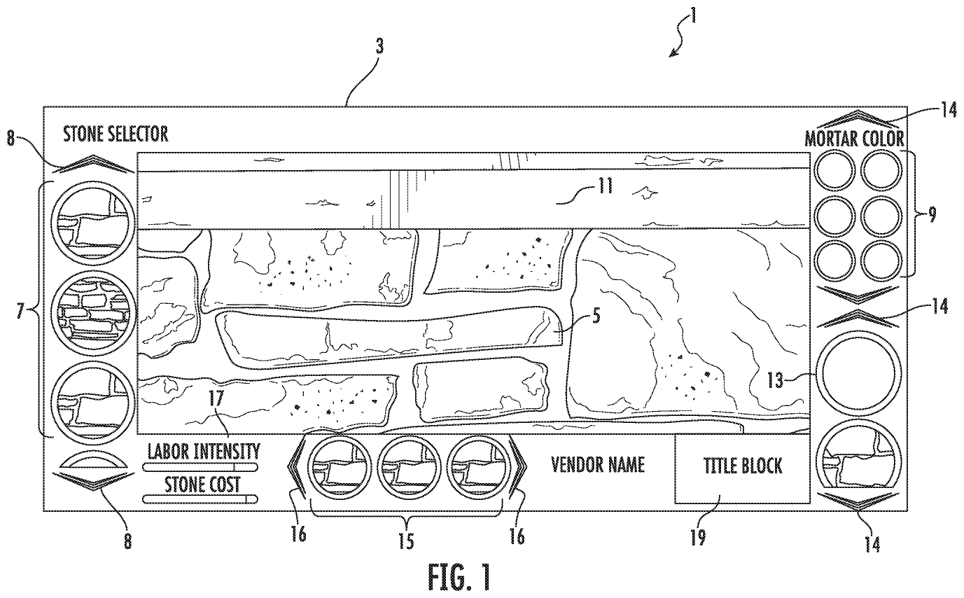

With reference to FIG. 1 of the drawings, a computer-aided interactive design tool/apparatus 1 is shown, constructed in accordance with the present invention. The interactive design tool/apparatus 1 of the present invention is capable of simplifying and organizing the process of selecting and procuring the correct stone (natural or artificial) and mortar for any given masonry project. In the embodiment shown, it is contemplated that a user-friendly interactive computer or television monitor 3 be provided which is capable of visually displaying computer-generated stone/mortar combination panel images 5 based on available stone and mortar selections of represented vendor(s). With the interactive design tool/apparatus 1, associated vendor database(s) of stone and mortar samples may be accessed by the user for review and selection. The customer and contractor may pick and choose amongst various stone vendors and mix and match available stonework to create the design of choice for the masonry project at hand.

With further reference to FIG. 1, it can be seen that a user-interactive selection module 7 for displaying available stone samples is provided immediately adjacent the combined panel image 5. The interactive module 7 includes a scroll bar 8 (arrows above and below images) which allows the user to scroll back and forth through numerous images of available stone samples for viewing and selection. While the stone scrollbar 7 is shown on the left-hand side of the combined panel image 5, it will be appreciated that it could be located elsewhere on the display monitor 3 without departing from the invention herein. Also, although the interactive stone selection module 7 is shown to incorporate a scrollbar for use with a mouse, it will be appreciated that the use of other computer user-interactive selection methods (e.g., touchscreen, keyboard interaction, menu selection, etc.) are conceivable, provided they are suitable for use in displaying and selecting appropriate vendor stone samples on the display monitor 3.

In the embodiment shown in FIG. 1, stone selection module 7 displays a series of three (3) vertically spaced circular windows of various different samples of available stone that may be selected. Of course, the number and manner of display of the available stone samples can vary without departing from the invention herein. The available samples may be scrolled through using scrollbar 8 for preview prior to selecting same. Once a desired stone is identified, it may be easily selected by tapping on the appropriate sample display, which will then automatically populate the selected stone sample into the combined panel image 5 at the center of the display monitor 3.

In a similar manner, a mortar selection module 9, including a similar scrollbar may also be provided for review and selection of desired mortar samples to be used with the selected stone. While mortar selection module 9 is shown on the right-hand side of the combined panel image 5, it will be appreciated that it also could be located elsewhere on the display monitor 3 without departing from the invention herein. Also, although the interactive mortar selection module 9 is shown in the form of a scrollbar, it will be appreciated that other computer interactive selection features similar to that disclosed above are conceivable, provided they are suitable for use in displaying and selecting appropriate vendor mortar samples on the display monitor 3.

As illustrated in FIG. 1, the mortar selection module 9 displays at any given time several color samples of available mortar to choose from. The available samples of mortar may be scrolled through on the selection scrollbar 9 for preview prior to selecting same. Once a desired mortar is identified, it may be easily selected by tapping on the appropriate sample display, which will then automatically populate the selected mortar sample into the combined panel image 5 at the center of the display monitor 3, such that the user may view the actual mortar color in combination with the selected stone.

With further reference to FIG. 1, it is also contemplated that available sill stone options may be displayed for selection and incorporation into the central integrated panel image 5, such that the user can review a fully integrated display of selected stones (exterior and sill), together with available mortar combinations. Similar to other user-interactive selection modules, a sill stone selection module 13 may be provided to help in selecting an appropriate sill stone and sill color for use in combination with the exterior stone and mortar selections. In FIG. 1, a display associated with the sill stone selection module 13 is located in the lower right-hand corner of the display monitor 3, but here again, it will be appreciated that it could also be located elsewhere on the display monitor 3 without departing from the invention herein. Also, while the interactive sill stone selection module 13 is shown to function as a scrollbar 14 (arrows above and below images), it will be appreciated that other known computer interactive selection features (such as that discussed previously) are conceivable, provided they are suitable for use in displaying and selecting appropriate sill stone samples on the display monitor 3.

As shown in FIG. 1, it is contemplated further that the display 11 of the selected sill stone may be located immediately atop the combined stone/mortar display in the composite image 5, such that one can easily visualize the entire combination of selected stones and mortar together. While the sill stone display 11 is shown positioned in the top portion of the main integrated panel image 5 for convenience of the viewer, it will be appreciated that it could be located elsewhere on the display monitor 3 without departing from the invention herein.

The sill stone selection module 13 allows the user to scroll through multiple samples of sill stone colors and style using the associated scrollbar for preview prior to selecting same. Once a desired sill stone is identified, it may be easily selected by tapping on the appropriate sample display, which will then automatically populate the selected sill stone sample into the combined panel image 5 at the center of the display monitor 3, such that the user may view the actual sill stone in combination with the selected exterior stone and mortar. In this regard, visual displays of numerous available sill stone options can be incorporated into the overall design for display on the interactive display monitor 3.

Still further, another user-interactive selection module 15 with a similar scrollbar operating tool 16 (arrows on opposite sides of images) may also be incorporated into the interactive display monitor 3 for controlling the selection and display of optional variants of the joints formed of mortar. Using the interactive technique of scrollbar 16, in this embodiment, alterations can be made to the displayed mortar joints of the combined image 5 to change the joint depth, joint width, joint finishes, patterns, etc. Such alterations, as selected, are automatically integrated into the main central image display 5 such that the user can visualize how the stone and mortar joints come together as a finished unit. Here again, it will be appreciated that the location of the module 15 and scrollbar 16 may be altered without departing from the invention herein. Also, it will be appreciated that other types of computer interactive selection features are conceivable, provided they are suitable for use in displaying and selecting available mortar variants on the display monitor 3.

With the selection of various available stone and mortar samples, the enlarged central integrated image 5 is easily and conveniently updated on a continuous basis so as to display the various selected combinations of stone and mortar. With a large life-like integrated display format, each user can mix and match stone and mortar combinations from selected vendors, as desired, and visually consider and save any number of desirable combinations for subsequent comparison and final selection.

Although not depicted in the drawings, the foregoing computer-aided interactive design tool/apparatus 1 may also include an optional search feature which may be used to search and identify specific vendors, or known stone and/or mortar samples/colors, etc. Such a search box feature may be incorporated into the display monitor 3 at any convenient location to allow the user to conduct a keyword search based on known information as to vendor names, or possibly other stone/masonry features that may be of interest and helpful to narrow the search and selection efforts of the user.

Other features of the present invention may also include the calculation and auto display on monitor 3 of the estimated total cost for a given masonry project. This information could be derived from predetermined data collected as to the intensity of labor required to work with various known stone materials, as well as known material costs associated with the stone/mortar selections being made. As shown in FIG. 1, a live cost analysis display 17, including the associated labor, material cost and estimated total project cost may be calculated and auto-populated onto the monitor screen 3 based on data collected from user-selected stone/mortar images, as such selections are made and/or modified. By providing a continual update of the estimated associated cost of a masonry project, the contractor and customer may be kept fully aware of the potential cost for any given selection of materials. This feature is extremely helpful for customers and contractors that are operating under a strict budget.

Still further, as shown in FIG. 1, all relevant data pertaining to selections being made can also be auto-displayed and continually updated during the selection process in a title block 19 shown in the lower right-hand corner of the monitor screen 3. This title block display 19 could include, amongst other things, the name of selected vendor(s), the stone and mortar selection, colors, pattern, geographic origin of stone, quarry location, sill style/color, joint width/depth/style, etc. Although the title block 19 is shown in the lower right-hand corner of the display monitor 3 in FIG. 1, it will be appreciated that such display could be located elsewhere on the display monitor 3 without departing from the invention herein.

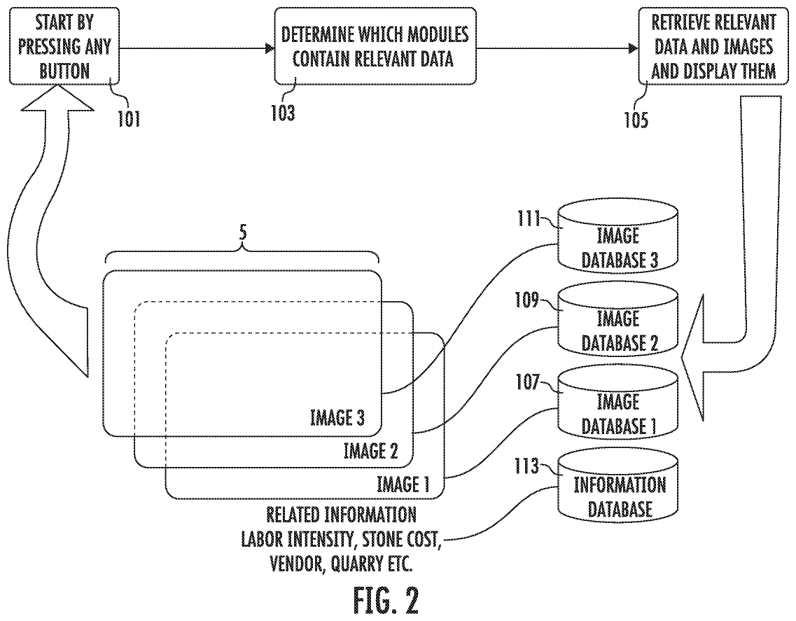

With reference now being made to FIG. 2, the general process used to select and modify different vendor stone, mortar and sill combinations on the interactive design tool/apparatus 1 is shown. As seen from FIG. 2, the combined stone/mortar/sill panel image 5 displayed on the monitor screen 3 is formed as a composite of multiple overlapping images (three images shown in FIG. 2), integrated with and/or overlaid upon one another to develop a combined virtual masonry creation. At step 101 of the process, a simple tap on any user-interactive selection module (7, 9 13, 15) or other display icon will activate the interactive design tool/apparatus 1. Once activated, as shown at step 103, the user may determine and select the desired selection module(s) (e.g., stone, mortar or sill) associated with any one or all of the registered stone/mortar source vendor(s) to work from. Desired stone/mortar combinations may then be retrieved, displayed and previewed at step 105. As stone, mortar, sill selections, etc., are made from the various selection modules, all relevant data is transferred and stored in one or more associated image databases (107, 109, 111) for display and viewing on monitor 3 of the interactive design tool/apparatus 1 as a combined panel image 5 of stone/mortar creations.

Based on stone selections made during the selection process, as depicted by step 113 in the process, all available information relative to the selected stone/mortar/sill etc., including without limitation, vendor identity, stone and mortar type, colors, pattern, geographic origin of stone, quarry location, sill style/color, joint width/depth/style, labor intensity, stone cost, estimated project cost, etc., may be displayed on monitor 3 and updated automatically in title block module 19 throughout the selection process. Such data may be easily saved and displayed and/or printed for comparison with other selected combinations of stone, as the user sees fit.

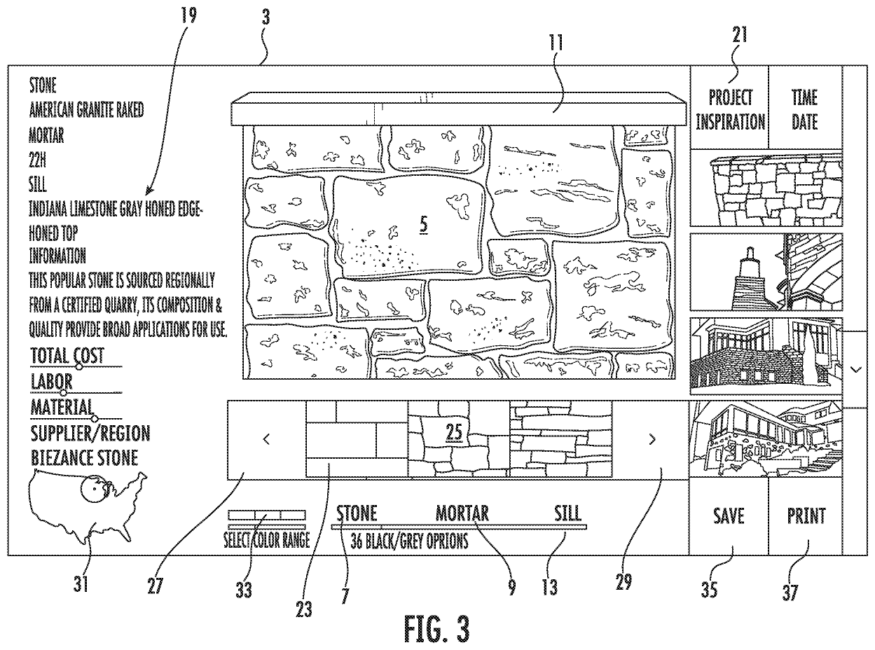

With reference now being made to FIG. 3, an alternate embodiment of the present invention is shown which incorporates additional features and a “project inspiration” module 21 for selection and use by the user. As shown in FIG. 3, in this embodiment, the basic function of the interactive design tool/apparatus 1 is the same as that described and shown in FIG. 1. The manner of display on monitor 3 has been altered, but the basic function is the same. In FIG. 3, it can be seen that the exterior “stone” selection module 7 has been selected for viewing at the base of the display monitor 3.

Upon selection of the “stone” selection module 7, all available stone samples are retrieved from the relevant computer data base and become viewable in the display preview area 25 of the scroll bar tool 23. By tapping on the left or right arrows (27, 29) of the scroll bar 23, images of available stone samples scroll across the display preview area 25 for viewing and selection by the user. This allows the user to automatically change the exterior stone in the enlarged composite image 5 based selections made from the stone selection module 7 located immediately below the composite image 5. Using the scroll bar 23, the user may preview all available vendor stone contained in the stone selection module 7. Upon finding and clicking upon a desired stone in module 7, the composite image 5 will automatically update to incorporate the newly selected stone image.

As seen further in FIG. 3, in this embodiment, the mortar selection module 9 and sill selection module 13 are also made available for user selection at the base of the display monitor 3, below the composite image 5. Each of the modules 13 and 19 function in the same manner as described above for the exterior stone selection module 7. Upon the selection of each, the available styles and color of mortar and sill options become available for preview on the scroll bar tool 23. Selection of the desired mortar from the mortar selection module 9 and sill stone from the sill selection module 13 will then be incorporated into the composite image 5. Similar selection modules for mortar joint variations, etc. may also be made available for user interaction and incorporation into the composite image 5. To help the user pair down the selection process even further, a color range selection module 33 may also be provided to limit the selectable stone and mortar colors to a desired range (e.g., darker vs. lighter; redder vs. browner, etc.).

Still further, a title block module 19 containing continually updated information as to selected vendor identity, stone, mortar and sill type, color, pattern, geographic origin of stone, quarry location, sill style/color, joint width/depth/style, labor intensity, stone cost, estimated total project cost, etc., may also be made available to the user at all times. As shown in FIG. 3, information as to a stone's geographic origin may also be provided by way of a map 31 showing the geographic region or part of a country to which a particular variety of stone is indigenous. Once desirable stone and mortar combinations are selected, they may be saved and/or printed by clicking on the appropriate “Save” icon 35 or “Print” icon 37 for the user's convenience and later comparison.

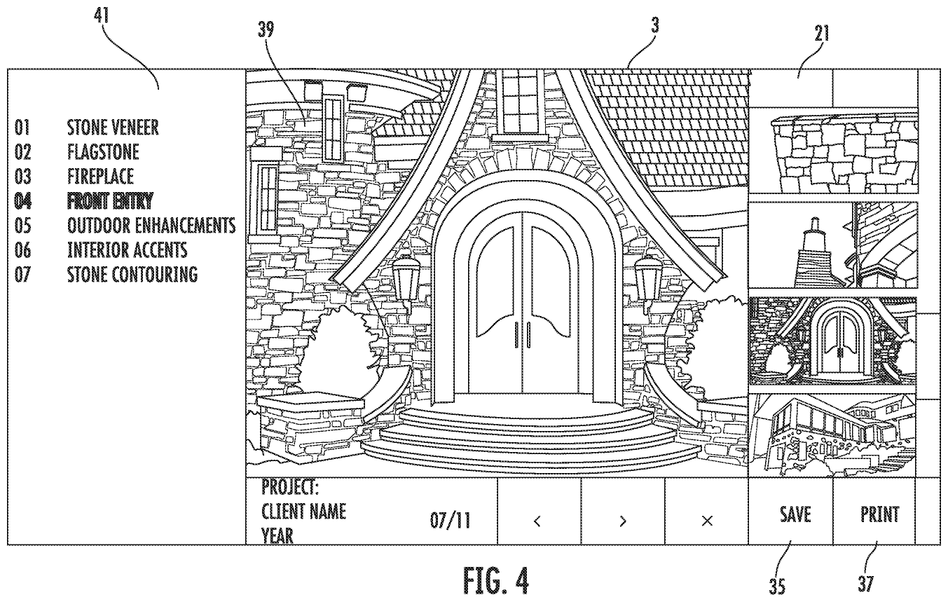

The project inspiration module 21 (located to the right of image 5 in FIG. 3) is provided to present the user with an option for enhancing his or her visual experience of the selected stone combination(s). Upon selecting the project inspiration module 21, some or all of the user-selected images of which composite image 5 is comprised may automatically be incorporated into an integrated visual simulation 39 of one or more completed sections of a home or other building. As shown best in FIG. 4, with module 21, users may better visualize selected stone combinations in one or more natural settings, such as in the front entryway to a home, a stone veneer on a house, flagstone, stone contouring, window accents, patios, atriums and other exterior enhancements, or interior accents to homes, such as fireplaces, etc.

As shown in FIGS. 3 and 4, it is contemplated that a user may work in either a stone creation mode (FIG. 3) where the user may select, change and save desired stone combinations, or in a project inspiration mode (FIG. 4) where the user may enlarge the images generated in the project inspiration module 21 as an integrated visual simulation 39 for enhanced viewing of selected stone combinations in one or more natural settings. As shown in FIG. 4, in the project inspiration mode, a menu 41 may also be provided to permit the user to select various portions of a simulated home or other building, e.g., stone veneer facing; front entry; fireplace, upon which the user is interested in using the selected stone creation. In this manner, the user can better visualize the integration of some or all selected stone/mortar/sill/joint variations, etc., together in a more complete natural home environment. Here again, various visual simulations 39 may be saved and/or printed by clicking on the appropriate “Save” icon 35 or “Print” icon 37 for the user's convenience and later comparison.

Although not shown in the accompanying drawings, it is contemplated that other potential features could also be incorporated to enhance the interactive experience of selecting all design components for a particular masonry or construction project. This could include, amongst other things, similar selection modules for flagstone; siding/fascia/soffit/trim; roofing; cut stone for lintels, brackets, trim, etc.; and fireplaces. With the computer-aided interactive design tool/apparatus 1 of the present invention, customers and contractors alike may visit a single virtual display showroom where all desired design criteria of a masonry project can be selected, modified and visualized without the stress and anxiety associated with the conventional process of travelling to multiple stone/mortar showroom locations. One or more favorite combinations of stone/mortar selections can be easily saved for future retrieval under a user file for quick reference and consideration at any time.

Certain terminology is used herein for purposes of reference only, and thus is not intended to be limiting. For example, terms such as “upper”, “lower”, “above”, “below”, “top”, “bottom”, “upward”, “downward”, “rearward”, and “forward” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The disclosure herein is intended to be merely exemplary in nature and, thus, variations that do not depart from the gist of the disclosure are intended to be within the scope of the disclosure. Such variations are not to be regarded as a departure from the spirit and scope of the disclosure, which comprises the matter shown and described herein, and set forth in the appended claims.

1. A stonework selection and design apparatus, comprising:
(a) a visual display monitor connected in controlled relation to a computer in response to user interaction;
(b) a user-interactive stone selection module associated with the computer for accessing and displaying on the display monitor images of available vendor stone inventory from a vendor stone database stored in the computer;
(c) a user-interactive mortar selection module associated with the computer for accessing and displaying on the display monitor images of available vendor mortar inventory from a vendor mortar database stored in the computer; and
(d) user-selected images from the selection modules being combined and displayed on the display monitor as a composite image, where the composite image is automatically updated based on changes made to the user-selected images.

2. The stonework selection and design apparatus of claim 1, including a user-interactive sill selection module associated with the computer for accessing and displaying on the display monitor images of available vendor sill inventory from a vendor sill database stored in the computer.

3. The stonework selection and design apparatus of claim 1, including a user-interactive mortar joint variation selection module associated with the computer for accessing and displaying on the display monitor images of available mortar joint variations from a mortar joint variation database stored in the computer.

4. The stonework selection and design apparatus of claim 3, wherein the mortar joint variations include one or more variations taken from a group consisting of joint depth, joint width, joint finishes and joint patterns.

5. The stonework selection and design apparatus of claim 1, wherein the selection modules are connected in controlling relation to a cost-estimate display module, where the cost-estimate display module automatically updates estimated project cost information being displayed on the display monitor based on changes made to the user-selected images.

6. The stonework selection and design apparatus of claim 5, wherein the cost-estimate display module provides an estimate of total project cost based on predetermined estimates for material cost and associated labor intensity in connection with the user-selected images.

7. The stonework selection and design apparatus of claim 1, wherein the selection modules are connected in controlling relation to a title block display module which displays product information as to the user-selected images on the display monitor, where the title block display module automatically updates the product information being displayed based on changes made to the user-selected images.

8. The stonework selection and design apparatus of claim 7, wherein the product information includes information from one or more of a group consisting of vendor identification, stone identification, mortar identification, stone color, mortar color, stone pattern, sill style, sill color, joint width, joint depth, joint style, stone geographical origin and quarry location.

9. The stonework selection and design apparatus of claim 1, wherein the selection modules are connected in controlling relation to a project inspiration module which displays a simulated model of a preselected area of a completed building on the display monitor based on data obtained from the user-selected images.

10. A stonework selection and design apparatus, comprising:
(a) a visual display monitor connected in controlled relation to a computer in response to user interaction;
(b) a first user-interactive selection module associated with the computer for accessing and displaying on the display monitor images of available vendor inventory stored on the computer for a first category of building components;
(c) a second user-interactive selection module associated with the computer for accessing and displaying on the display monitor images of available vendor inventory stored on the computer for a second category of building components; and
(d) user-selected images from the selection modules being combined and displayed on the display monitor as a composite image which simulates a portion of a completed construction project using the building components of the user-selected images, where the composite image is automatically updated based on changes made to the user-selected images.

11. The stonework selection and design apparatus of claim 10, wherein the first category of building components includes at least one of a group consisting of natural and artificial stone.

12. The stonework selection and design apparatus of claim 11, wherein the second category of building components comprises a mortar used to bind sections of the first category of building components together.

13. The stonework selection and design apparatus of claim 12, including a third user-interactive selection module associated with the computer for accessing and displaying on the display monitor images of available mortar joint variations from a mortar joint variation database stored in the computer.

14. The stonework selection and design apparatus of claim 11, wherein the second category of building components includes at least one of a group consisting of mortar, flagstone, siding, fascia, soffit, trim, roofing, cut stone for lintels, brackets, and fireplace components.

15. The stonework selection and design apparatus of claim 10, wherein the selection modules are connected in controlling relation to a title block display module which displays product information as to the user-selected images on the display monitor, where the title block display module automatically updates the product information being displayed based on changes made to the user-selected images.

16. The stonework selection and design apparatus of claim 10, wherein the selection modules are connected in controlling relation to a project inspiration module which displays a simulated model of a preselected area of a completed building on the display monitor based on data obtained from the user-selected images.

17. A method of stonework selection and design, comprising the steps of:
(a) providing a visual display monitor connected in controlled relation to a computer in response to user interaction;
(b) interacting with a user-interactive stone selection module associated with the computer to access and display on the display monitor images of available vendor stone inventory from a vendor stone database stored in the computer;
(c) interacting with a user-interactive mortar selection module associated with the computer to access and display on the display monitor images of available vendor mortar inventory from a vendor mortar database stored in the computer; and
(d) retrieving a set of user-selected images from the selection modules and combining the user-selected images for display on the display monitor as a composite image, where the composite image is automatically updated based on changes made to the user-selected images.

18. The method of stonework selection and design of claim 17, including the step of interacting with a user-interactive sill selection module associated with the computer to access and display on the display monitor images of available vendor sill inventory from a vendor sill database stored in the computer.

19. The method of stonework selection and design of claim 17, wherein the step of retrieving a set of user-selected images from the selection modules includes retrieving and displaying on the display monitor estimated total project costs based on predetermined estimates for cost of material and associated labor intensity in connection with the user-selected images, where the cost estimates displayed automatically update based on changes made to the user-selected images.

20. The method of stonework selection and design of claim 17, wherein the step of retrieving a set of user-selected images from the selection modules includes generating a simulated model, for selective display on the display monitor, of a preselected area of a completed building based on data obtained from the user-selected images.
